(19) United States
(12) Patent Application Publication
(10) Pub. No.: US 2018/0247605 A1
(43) Pub. Date: Aug. 30, 2018

(54) DISPLAY DRIVING CIRCUITS, DRIVING METHODS AND DISPLAY APPARATUSES

(71) Applicants: BOE Technology Group Co., Ltd., Beijing (CN); Hefei Xinsheng Optoelectronics Technology Co., Ltd., Hefei (CN)

(72) Inventors: Yanping ZHANG, Beijing (CN); Tao MA, Beijing (CN)

(73) Assignees: BOE Technology Group Co., Ltd.; Hefei XINSHENG Optoelectronics Technologg Co., Ltd

(21) Appl. No.: 15/574,340

(22) PCT Filed: Apr. 25, 2017
(86) PCT No.: PCT/CN2017/081840

§ 371 Date: Nov. 15, 2017

(30) Foreign Application Priority Data
May 31, 2016 (CN) 201610374532.0

(51) Int. Cl. G09G 3/36

(52) U.S. Cl. CPC G09G 3/3696; G09G 3/3648; H02M 3/00; G09G 2310/0291; G09G 2330/021

(57) ABSTRACT

The embodiments of the present disclosure relate to a display driving circuit, a driving method and a display apparatus. The display driving circuit comprises a voltage converter having at least one direct current voltage output branch; and a current sampler provided on at least a part of the at least one direct current voltage output branch and configured to detect a value of current flowing through a direct current voltage output branch where the current sampler is located and output an associated voltage related to the a value of the current at an output terminal; wherein the output terminal of the current sampler is connected to the voltage converter, and the voltage converter is configured to adjust a direct current voltage output at the corresponding direct current voltage output branch according to the associated voltage from the current sampler.

### CROSS-REFERENCE TO RELATED APPLICATION(S)

This application is a National Stage Application of PCT International Application No. PCT/CN2017/081840, which claims priority to the Chinese Patent Application No. 201610374532.0, filed on May 31, 2016, which is incorporated herein by reference in its entirety

### TECHNICAL FIELD

The embodiments of the present disclosure relate to display technology, and more particularly, to a display driving circuit, a driving method and a display apparatus.

### BACKGROUND

Thin Film Transistor-Liquid Crystal Display (TFT-LCD) display panels are increasingly applied in high-performance display fields. In a TFT-LCD display panel, a voltage converter provides the rest of the circuit board with voltage supply, including a digital voltage (DVDD) and an analog voltage (AVDD). However, in the conventional technology, the digital voltage can reach a gate driver only if the digital voltage passes through a circuit wiring on the circuit board and a bonding line on a Flexible Printed Circuit (FPC) board, during which the digital voltage may be influenced by a line loss to some extent.

### SUMMARY

The embodiments of the present disclosure provide a display driving circuit and a display apparatus.

According to an aspect of the embodiments of the present disclosure, there is provided a display driving circuit, comprising: a voltage converter having at least one direct current voltage output branch; and a current sampler provided on at least a part of the at least one direct current voltage output branch and configured to detect a value of current flowing through a direct current voltage output branch where the current sampler is located and output a voltage representing the value of the current at an output terminal;

wherein the output terminal of the current sampler is connected to the voltage converter, and the voltage converter is configured to adjust a direct current voltage output at the corresponding direct current voltage output branch according to the voltage from the current sampler, so that the value of the current flowing through the corresponding direct current voltage output branch is stabilized at a preset value related to a target output voltage value.

In an example, the current sampler comprises a first resistor, a second resistor, a third resistor, a fourth resistor, a fifth resistor and an operational amplifier, wherein

the first resistor is provided on the direct current voltage output branch, and has two terminals connected to a first terminal of the second resistor and a first terminal of the fourth resistor respectively;

both of a second terminal of the second resistor and a first terminal of the third resistor are connected to a negative input terminal of the operational amplifier;

both of a second terminal of the fourth resistor and a first terminal of the fifth resistor are connected to a positive input terminal of the operational amplifier;

both of a second terminal of the third resistor and an output terminal of the operational amplifier are connected to the output terminal of the current sampler; and

a second terminal of the fifth resistor is connected to a common terminal.

In an example a resistance value R₁ of the first resistor, a resistance value R₂ of the second resistor, a resistance value R₄ of the fourth resistor and a resistance value R₅ of the fifth resistor satisfy the following relationship:

$$\frac{{R}_{5}}{{R}_{4}} = \frac{{R}_{2}}{{R}_{1}} .$$

In an example the associated voltage Vₒ output at the output terminal of the current sampler satisfies the following relationship:

$$\frac{{R}_{3}}{{R}_{2}} * {R}_{1} * I = {V}_{o} ,$$

where I is the value of the current of the direct current voltage output branch, and R₃ is the resistance value of the third resistor.

In an example the voltage converter comprises:

an acquisition unit connected to the current sampler and configured to acquire the value of the current flowing through the corresponding voltage output branch according to the voltage output at the output terminal of the connected at least one current sampler;

a calculation unit connected to the acquisition unit and configured to calculate a difference value between the value of the current acquired by the acquisition unit and the preset value; and

an adjustment unit connected to the calculation unit and configured to adjust a direct current voltage output at the corresponding direct current voltage output branch according to the difference value acquired by the calculation unit, so that the value of the current flowing through the corresponding direct current voltage output branch is close to the preset value.

In an example, the display driving circuit further comprises at least one of a gate driver, a timing controller and a source driver.

In an example, the at least one direct current voltage output branch comprises a direct current voltage output branch, which is configured to provide a direct current voltage to a gate driver and has the current sampler provided thereon.

In an example, the at least one direct current voltage output branch comprises a direct current voltage output branch, which is configured to provide a direct current voltage to a timing controller and has the current sampler provided thereon.

In an example, the at least one direct current voltage output branch comprises a direct current voltage output branch, which is configured to provide a direct current voltage to a source driver and has the current sampler provided thereon.

According to another aspect of the embodiments of the present disclosure, there is further provided a display apparatus, comprising any of the display driving circuits described above.

According to another aspect of the embodiments of the present disclosure, there is further provided a driving method of the display driving circuit described above, comprising:

detecting, by the current sampler, a value of current flowing through a direct current voltage output branch where the current sampler is located and outputting an associated voltage related to the detected value of the current at the output terminal of the current sampler; and

adjusting, by the voltage converter, a direct current voltage output at the corresponding direct current voltage output branch according to the associated voltage from the current sampler, so that the value of the current flowing through the corresponding direct current voltage output branch is stabilized at a preset value related to a target output voltage value.

In an embodiment, stabilizing the value of the current flowing through the corresponding direct current voltage output branch at a preset value related to a target output voltage value comprises: acquiring the value of the current of the corresponding voltage output branch according to the associated voltage output at the output terminal of the connected at least one current sampler; calculating a difference value between the acquired value of the current and the preset value; and adjusting the direct current voltage output at the corresponding direct current voltage output branch according to the acquired difference value, so that the value of the current flowing through the corresponding direct current voltage output branch is close to the preset value.

### BRIEF DESCRIPTION OF THE DRAWINGS

In order to more clearly illustrate the technical solutions according to the embodiments of the present disclosure or the conventional technical solutions, the accompanying drawings used in the description of the embodiments or the description of the conventional technology will be described below, and it will be apparent that the accompanying drawings in the following description are some embodiments of the present disclosure, and other accompanying drawings may be acquired by those of ordinary skill in the art according to these accompanying drawings without contributing any creative labor.

FIG. 1 is a basic architecture diagram of a TFT-LCD display driver;

FIG. 2 is a partial circuit structural diagram of a display driving circuit according to an embodiment of the present disclosure;

FIG. 3 is a partial circuit structural diagram of a display driving circuit according to another embodiment of the present disclosure;

FIG. 4 is a circuit block diagram of a voltage converter according to an embodiment of the present disclosure; and

FIG. 5 is a schematic flowchart of a driving method of a display driving circuit according to an embodiment of the present disclosure.

### DETAILED DESCRIPTION

In order to make the purposes, technical solutions and advantages of the embodiments of the present disclosure more clear, the technical solutions according to the embodiments of the present disclosure will be described clearly and completely in conjunction with the accompanying drawings in the embodiments of the present disclosure. It will be apparent that the described embodiments are some of the embodiments of the present disclosure, instead of all the embodiments. All other embodiments obtained by those of ordinary skill in the art based on the embodiments of the present disclosure without contributing any creative labor are within the protection scope of the present disclosure.

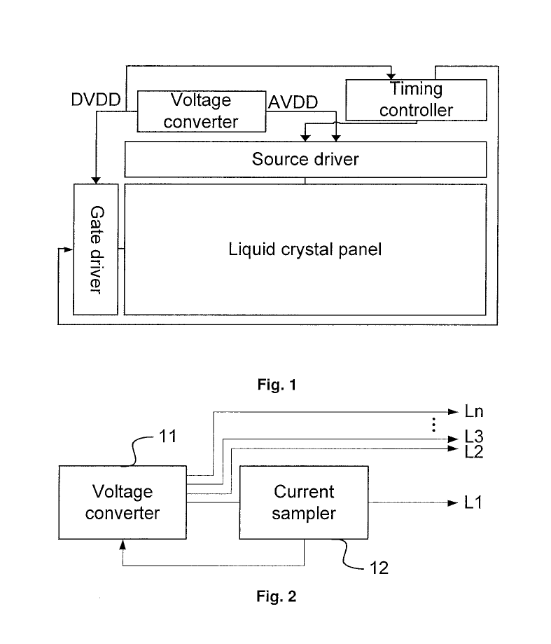

FIG. 1 illustrates a basic architecture diagram of a TFT-LCD panel driver. As shown in FIG. 1, the architecture may comprise a Liquid Crystal Display (LCD) panel, a gate driver, a source driver, a voltage converter (for example, a DC-DC converter), and a timing controller (TCON). The voltage converter provides the rest of the circuit board with voltage supply, including a digital voltage (DVDD) and an analog voltage (AVDD). Therefore, a voltage value received by the gate driver may be lower than a voltage value output by the voltage converter. In addition, in the display process, with switching of a display screen, there is a significant fluctuation in a load of the analog voltage. When the load is large, a high analog voltage is required. However, due to a line loss, there may be a situation in which a voltage value of the analog voltage may be low. In this case, the actual voltage value lower than a normal value cannot meet the requirements that a voltage value is higher than the normal value, and an operation timing of the gate driver may go wrong, thereby resulting in abnormal display of the entire screen. In addition, although the output voltage of the voltage converter can be increased according to a maximum load situation to avoid occurrence of abnormal conditions, the high voltage will not only increase the power consumption, but also cause a series of problems such as reduced life of a device.

FIG. 2 is a partial circuit structural diagram of a display driving circuit according to an embodiment of the present disclosure. As shown in FIG. 2, the display driving circuit according to the embodiment of the present disclosure may comprise a voltage converter 11 having at least one direct current voltage output branch. FIG. 2 illustrates n direct current voltage output branches L1, L2, L3, . . . , and Ln as an example, where n is an integer greater than or equal to 1. It should be illustrated that the “display driving circuit” as used herein refers to all or a part of circuit structures in a display apparatus which are used to provide a driving signal to a light emitting unit according to an input display signal. It is to be understood that each of the direct current voltage output branches of the voltage converter 11 included in the display driving circuit may provide a direct current voltage to other circuit structures. Here, the “other circuit structures” may be included in the display driving circuit, or may also be circuit structures connected to the display driving circuit.

By taking the direct current voltage output branch L1 as an example, in the embodiment of the present disclosure, a current sampler 12 is provided on at least some direct current voltage output branches for example, L1, of the at least one direct current voltage output branch and is configured to detect a value of current flowing through a direct current voltage output branch for example, L1, where the current sampler 12 is located and output an associated voltage related to the value of the current at an output terminal. As shown in FIG. 2, the output terminal of the current sampler 12 is connected to the voltage converter 11, so that the voltage converter 11 adjusts a direct current voltage output at the direct current voltage output branch L1 according to the associated voltage from the current sampler 12, and thereby the value of the current flowing through the direct current voltage output branch L1 is stabilized at a preset value related to a target output voltage value. It will be appreciated by those skilled in the art that the preset value may be set according to application requirements.

The value of the current detected by the current sampler 12 may be used to calculate a load condition and/or a line loss voltage drop. For example, with respect to the voltage converter 11 which outputs a constant direct current voltage to the direct current voltage output branch, the larger the load of the direct current voltage output branch, the smaller the current. Thus, the value of the output direct current voltage may be adjusted according to the value of the current on the direct current voltage output branch, so that the current is stabilized at the preset value. Specifically, if the current is small, it indicates that the load of the direct current voltage output branch is large, and therefore it needs to increase the output direct current voltage to make the direct current voltage received by the load be large enough; and if the current is large, it indicates that the load of the direct current voltage output branch is small, and the output direct current voltage may be reduced to reduce power consumption. Of course, the preset value is determined according to the value of the direct current voltage to be actually provided to the load, and will not be repeated here.

On the other hand, the voltage converter 11 may further determine the current line loss voltage drop according to the value of the current on the direct current voltage output branch. For example, if a value of a direct current voltage which is actually received by a circuit structure to which the direct current voltage output branch L1 is connected is Vₐ, a value of the direct current voltage output by the voltage converter 11 at the direct current voltage output branch L1 is V_{b}, the value of the current collected by the current sampler 12 in the direct current voltage output branch L1 is I, and a value of total resistance on the direct current voltage output branch L1 is r₀, Vₐ=V_{b}−Ir₀. In practical operations, V_{b} may be adjusted by the voltage converter 11 and r₀ may be known in advance and is almost invariant during use. Therefore, according to the above equation, the line loss voltage drop may be calculated as (V_{b}−Vₐ)=Ir₀ from the value I of the current on the direct current voltage output branch L1. Thus, the voltage converter 11 may determine the value of the direct current voltage output at the corresponding direct current voltage output branch according to both of the load condition and the line loss condition to meet the practical application requirements.

According to the embodiments of the present disclosure, the value of the current of the branch may be output to the voltage converter as a feedback based on the related setting of the current sampler, so that the voltage converter may adjust the voltage of the branch according to a practical load condition to stabilize the current of the branch at a preset value to ensure normal operations on the load side. Thus, the embodiments of the present disclosure avoid the problem that the output voltage of the voltage converter may be too low as the load varies. Compared with the conventional technology, the embodiments of the present disclosure can not only avoid abnormal operations, but also can effectively reduce the power consumption and facilitate improving the product performance.

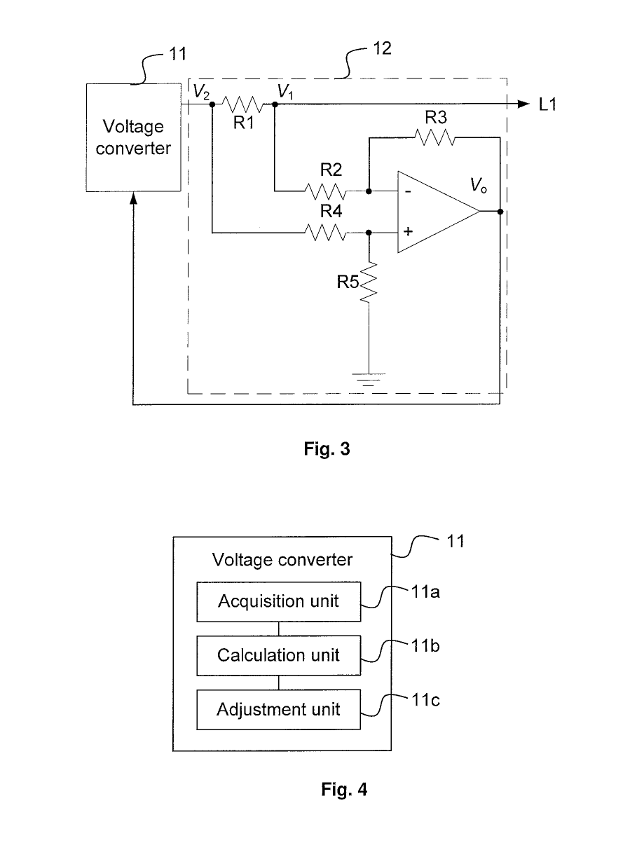

FIG. 3 is a partial circuit structural diagram of a display driving circuit according to an embodiment of the present disclosure. As shown in FIG. 3, a current sampler 12 according to the embodiment of the present disclosure may comprise a first resistor R1, a second resistor R2, a third resistor R3, a fourth resistor R4, a fifth resistor R5, and an operational amplifier. By taking a direct current voltage output branch L1 as an example, as shown in the figure, the first resistor R1 is provided on the direct current voltage output branch L1, and has two terminals connected to a first terminal of the second resistor R2 and a first terminal of the fourth resistor R4 respectively; both of a second terminal of the second resistor R2 and a first terminal of the third resistor R3 are connected to a negative input terminal (i.e., a position marked with “−” in the figure) of the operational amplifier; both of a second terminal of the fourth resistor R4 and a first terminal of the fifth resistor R5 are connected to a positive input terminal (i.e., a position marked with “+” in the figure) of the operational amplifier; both of a second terminal of the third resistor R3 and an output terminal of the operational amplifier are connected to the output terminal of the current sampler 12, and then are connected to the voltage converter 11; and a second terminal of the fifth resistor R5 is connected to a common terminal. Thus, the operational amplifier may collect a voltage difference value (V₂−V₁) between the two terminals of the first resistor R1 and acquire an associated voltage value related to the value of the current on the direct current voltage output branch L1 based on resistance values of the first resistor to the fifth resistor.

For example, the resistance value R₁ of the first resistor, the resistance value R₂ of the second resistor, the resistance value R₄ of the fourth resistor, and the resistance value R₅ of the fifth resistor satisfy the following relationship:

$$\frac{{R}_{5}}{{R}_{4}} = \frac{{R}_{2}}{{R}_{1}}$$

Therefore, the associated voltage Vₒ output at the output terminal of the current sampler satisfies:

$$\frac{{R}_{3}}{{R}_{2}} * {R}_{1} * I = {V}_{o} ,$$

where I is the value of the current on the direct current voltage output branch L1 and R₃ is the resistance value of the third resistor. Thus, when the resistance values of the first resistor, the second resistor, and the third resistor are constant, I and Vₒ are proportional to each other, so that I can be represented by Vₒ. The voltage converter 11 may pre-store the resistance values of the first resistor to the third resistor so as to acquire the value I of the current on the direct current voltage output branch L1 from the received voltage value Vₒ according to the above equation, for subsequent processing.

FIG. 4 is a circuit structural block diagram of a voltage converter according to an embodiment of the present disclosure. As shown in FIG. 4, the voltage converter 11 according to the embodiment of the present disclosure may comprise: an acquisition unit 11a connected to a current sampler and configured to acquire a value of current of a corresponding direct current voltage output branch according to an associated voltage output at an output terminal of the connected at least one current sampler; a calculation unit 11b connected to the acquisition unit and configured to calculate a difference value between the value of the current acquired by the acquisition unit and a preset value; and an adjustment unit 11c connected to the calculation unit and configured to adjust a direct current voltage output at the corresponding direct current voltage output branch according to the difference value acquired by the calculation unit, so that the value of the current flowing through the corresponding direct current voltage output branch is close to the preset value.

Therefore, with the acquisition unit 11a, the calculation unit 11b, and the adjustment unit 11c described above, the value of the current flowing through the direct current voltage output branch L1 can be stabilized at the preset value related to a target output voltage value through negative feedback adjustment of the direct current voltage output at the direct current voltage output branch. The preset value may be set according to application requirements.

In addition, it is to be illustrated that any of the display driving circuits described above may further comprise at least one of a gate driver, a timing controller and a source driver, so that each of the gate driver, the timing controller and the source driver serves as a load of the voltage converter 11, and acquires a required direct current voltage through corresponding one or more direct current voltage output branches. For example, the at least one direct current voltage output branch may comprise a direct current voltage output branch, which is configured to provide a direct current voltage to the gate driver and has a current sampler provided thereon. As a result, the effect of the line loss and the load variation on the operation voltage output to the gate driver can be reduced. For example, the at least one direct current voltage output branch comprises a direct current voltage output branch, which is configured to provide a direct current voltage to the timing controller and has a current sampler provided thereon. As a result, the effect of the line loss and the load variation on the operation voltage output to the timing controller can be reduced. In addition, the at least one direct current voltage output branch may comprise a direct current voltage output branch, which is configured to provide a direct current voltage to the source driver and has a current sampler provided thereon. As a result, the effect of the line loss and the load variation on the operation voltage output to the source driver can be reduced. Of course, the display driving circuit described above may also not comprise at least one of the gate driver, the timing controller, and the source driver, and any of the direct current voltage output branches described above serves as a corresponding output terminal, to output a direct current voltage to at least one of the gate driver, the timing controller, and the source driver.

Based on the same concept, the embodiments of the present disclosure provide a display apparatus comprising any of the display driving circuits described above, thereby avoiding the problem that the output voltage of the voltage converter may be too low as the load varies, which not only avoids abnormal operations, but also can effectively reduce power consumption, and facilitates improving the product performance. It should be illustrated that the display apparatus according to the embodiments of the present disclosure may be any product or component having a display function, such as a display panel, an electronic paper, a mobile phone, a tablet computer, a television set, a notebook computer, a digital photo frame, a navigator etc.

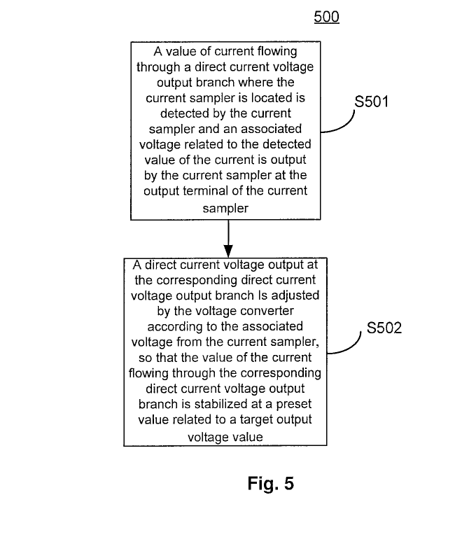

The embodiments of the present disclosure further provide a driving method of the display driving circuit described above. As shown in FIG. 5, the driving method 500 may comprise the following steps.

In step S501, a value of current flowing through a direct current voltage output branch where the current sampler is located is detected by the current sampler and an associated voltage related to the detected value of the current is output by the current sampler at the output terminal of the current sampler.

In step S502, a direct current voltage output at the corresponding direct current voltage output branch is adjusted by the voltage converter according to the associated voltage from the current sampler, so that the value of the current flowing through the corresponding direct current voltage output branch is stabilized at a preset value related to a target output voltage value.

In an example, stabilizing the value of the current flowing through the corresponding direct current voltage output branch at a preset value related to a target output voltage value may further comprise: acquiring the value of the current of the corresponding voltage output branch according to the associated voltage output at the output terminal of the connected at least one current sampler; calculating a difference value between the acquired value of the current and the preset value; and adjusting the direct current voltage output at the corresponding direct current voltage output branch according to the acquired difference value, so that the value of the current flowing through the corresponding direct current voltage output branch is close to the preset value.

It should be illustrated that, relational terms such as first and second herein are used only to distinguish an entity or operation from another entity or operation without necessarily requiring or implying that there is any such practical relationship or sequence between these entities or operations. Further, terms “comprising”, “including” or any other variant thereof are intended to encompass a non-exclusive inclusion so that processes, methods, articles or devices including a series of elements include not only those elements but also other elements that are not explicitly listed, or elements that are inherent to such processes, methods, articles, or devices. In the absence of more restrictions, the elements defined by the statement “including a . . . ” do not exclude the presence of additional identical elements in the processes, methods, articles, or devices that include the elements. An orientation or position relation indicated by terms such as “up”, “down” etc. is an orientation or position relation indicated in the accompanying drawings, and is merely used to conveniently describe the present disclosure and simplify the description, instead of indicating or implying that the indicated apparatus or element must have a particular orientation and must be constructed and operated in a particular orientation, and thus cannot be construed as limiting the present disclosure. Unless otherwise explicitly specified or defined, terms such as “be installed in”, “be connected with”, “be connected to” etc. should be construed in a generalized sense. For example, these terms may refer to “be fixedly connected to”, “be detachably connected to”, or “be integrally connected to”; or may be “be mechanically connected to”, or “be electrically connected to”; or may be “be directly connected to” or “be indirectly connected through an intermediate medium”, or may be “connectivity in two elements”. Specific meanings of the terms described above in the present disclosure can be understood by those of ordinary skill in the art according to specific conditions.

A number of specific details have been described in the specification of the present disclosure. However, it should be understood that the embodiments of the present disclosure may be practiced without these specific details. In some instances, well-known methods, structures and technologies have not been described in detail to avoid obscuring the specification. Similarly, it should be understood that in order to simplify the present disclosure and facilitate understanding of one or more of various aspects of the present disclosure, in the description of the exemplary embodiments of the present disclosure described above, various features of the present disclosure sometimes are grouped into a single embodiment, figure or description thereof.

It should be illustrated that the various embodiments described above are merely used to illustrate the technical solutions of the present disclosure, instead of limiting the present disclosure. Although the present disclosure has been described in detail with reference to the various embodiments described above, it should be understood by those skilled in the art that the technical solutions recited in the various embodiments described above can still be modified or a part or all of the technical features therein can be equivalently substituted. These modifications or substitutions, which are made without the essence of the corresponding technical solutions departing from the scope of the technical solutions of the various embodiments of the present disclosure, should be included in the scope of specification of the present disclosure.

1. A display driving circuit, comprising:
a voltage converter having at least one direct current voltage output branch; and
a current sampler provided on at least a part of the at least one direct current voltage output branch and configured to detect a value of current flowing through a direct current voltage output branch where the current sampler is located and output an associated voltage related to the detected value of the current at an output terminal;
wherein the output terminal of the current sampler is connected to the voltage converter, and the voltage converter is configured to adjust a direct current voltage output at the corresponding direct current voltage output branch according to the associated voltage from the current sampler, so that the value of the current flowing through the corresponding direct current voltage output branch is stabilized at a preset value related to a target output voltage value.

2. The display driving circuit according to claim 1, wherein the current sampler comprises a first resistor, a second resistor, a third resistor, a fourth resistor, a fifth resistor and an operational amplifier, wherein
the first resistor is provided on the direct current voltage output branch, and has two terminals connected to a first terminal of the second resistor and a first terminal of the fourth resistor respectively;
both of a second terminal of the second resistor and a first terminal of the third resistor are connected to a negative input terminal of the operational amplifier;
both of a second terminal of the fourth resistor and a first terminal of the fifth resistor are connected to a positive input terminal of the operational amplifier;
both of a second terminal of the third resistor and an output terminal of the operational amplifier are connected to the output terminal of the current sampler; and
a second terminal of the fifth resistor is connected to a common terminal.

3. The display driving circuit according to claim 2, wherein a resistance value R₁ of the first resistor, a resistance value R₂ of the second resistor, a resistance value R₄ of the fourth resistor and a resistance value R₅ of the fifth resistor satisfy the following relationship:
$$\frac{{R}_{5}}{{R}_{4}} = \frac{{R}_{2}}{{R}_{1}} .$$

4. The display driving circuit according to claim 3, wherein the associated voltage Vₒ output at the output terminal of the current sampler satisfies the following relationship:
$$\frac{{R}_{3}}{{R}_{2}} * {R}_{1} * I = {V}_{o} ,$$
where I is the value of the current of the corresponding direct current voltage output branch, and R₃ is the resistance value of the third resistor.

5. The display driving circuit according to claim 1, wherein the voltage converter comprises:
an acquisition unit connected to the current sampler and configured to acquire the value of the current of the corresponding voltage output branch according to the associated voltage output at the output terminal of the connected at least one current sampler;
a calculation unit connected to the acquisition unit and configured to calculate a difference value between the value of the current acquired by the acquisition unit and the preset value; and
an adjustment unit connected to the calculation unit and configured to adjust a direct current voltage output at the corresponding direct current voltage output branch according to the difference value acquired by the calculation unit, so that the value of the current flowing through the corresponding direct current voltage output branch is close to the preset value.

6. The display driving circuit according to claim 1, further comprising at least one of a gate driver, a timing controller and a source driver.

7. The display driving circuit according to claim 1, wherein the at least one direct current voltage output branch comprises a direct current voltage output branch, which is configured to provide a direct current voltage to a gate driver and has the current sampler provided thereon.

8. The display driving circuit according to claim 1, wherein the at least one direct current voltage output branch comprises a direct current voltage output branch, which is configured to provide a direct current voltage to a timing controller and has the current sampler provided thereon.

9. The display driving circuit according to claim 1, wherein the at least one direct current voltage output branch comprises a direct current voltage output branch, which is configured to provide a direct current voltage to a source driver and has the current sampler provided thereon.

10. A display apparatus, comprising the display driving circuit according to claim 1.

11. A driving method of the display driving circuit according to claim 1, comprising:
detecting, by the current sampler, a value of current flowing through a direct current voltage output branch where the current sampler is located and outputting an associated voltage related to the detected value of the current at the output terminal of the current sampler; and
adjusting, by the voltage converter, a direct current voltage output at the corresponding direct current voltage output branch according to the associated voltage from the current sampler, so that the value of the current flowing through the corresponding direct current voltage output branch is stabilized at a preset value related to a target output voltage value.

12. The driving method according to claim 11, wherein stabilizing the value of the current flowing through the corresponding direct current voltage output branch at a preset value related to a target output voltage value comprises:
acquiring the value of the current of the corresponding voltage output branch according to the associated voltage output at the output terminal of the connected at least one current sampler;
calculating a difference value between the acquired value of the current and the preset value; and
adjusting the direct current voltage output at the corresponding direct current voltage output branch according to the acquired difference value, so that the value of the current flowing through the corresponding direct current voltage output branch is close to the preset value.

13. A display apparatus, comprising the display driving circuit according to claim 2.

14. A display apparatus, comprising the display driving circuit according to claim 3.

15. A display apparatus, comprising the display driving circuit according to claim 4.

16. A display apparatus, comprising the display driving circuit according to claim 5.

17. A display apparatus, comprising the display driving circuit according to claim 7.

18. A display apparatus, comprising the display driving circuit according to claim 8.

19. A display apparatus, comprising the display driving circuit according to claim 9.
